(19) United States
(12) Patent Application Publication
(10) Pub. No.: US 2026/0051734 A1
(43) Pub. Date: Feb. 19, 2026

(54) SYSTEMS AND METHODS FOR GLOBAL HORIZONTAL IRRADIANCE FORECASTING FOR TOPOLOGY RECONFIGURATION OF PHOTOVOLTAIC SYSTEMS

(71) Applicants: Andreas Spanias, Tempe, AZ (US); Sameeksha Katoch, San Diego, CA (US); David Ramirez, Scottsdale, AZ (US); Pavan Turaga, Chandler, AZ (US); Cihan Tepedelenlioglu, Chandler, AZ (US)

(72) Inventors: Andreas Spanias, Tempe, AZ (US); Sameeksha Katoch, San Diego, CA (US); David Ramirez, Scottsdale, AZ (US); Pavan Turaga, Chandler, AZ (US); Cihan Tepedelenlioglu, Chandler, AZ (US)

(73) Assignee: Arizona Board of Regents on Behalf of Arizona State University, Tempe, AZ (US)

(21) Appl. No.: 19/303,226

(22) Filed: Aug. 18, 2025

Related U.S. Application Data
(60) Provisional application No. 63/684,295, filed on Aug. 16, 2024.

(51) Int. Cl. H02J 3/00; G06N 3/045; H02J 3/38

(52) U.S. Cl. CPC H02J 3/004; G06N 3/045; H02J 3/381; H02J 2203/20; H02J 2300/24

(57) ABSTRACT

A system implements a weather-based irradiance forecasting algorithm that can aid in planning PV array operations. The system implements a cascaded temporal convolutional network (TCN) neural architecture that uses nine weather characteristics in a time-bound window to predict future solar irradiance. The system achieves a significant performance improvement with as little as a single day prior of weather data compared to baseline results.

### CROSS-REFERENCE TO RELATED APPLICATIONS

This is a U.S. Non-Provisional Patent Application that claims benefit to U.S. Provisional Patent Application Ser. No. 63/684,295 filed Aug. 16, 2024, which is herein incorporated by reference in its entirety

### GOVERNMENT SUPPORT

This invention was made with government support under 2019068 awarded by the National Science Foundation. The government has certain rights in the invention.

### FIELD

The present disclosure generally relates to photovoltaic array control systems, and in particular, to a systems and associated methods for forecasting solar irradiance and adjusting photovoltaic system topology accordingly.

### BACKGROUND

Short-term irradiance forecasting is a fundamental research problem in optimizing utility-scale photovoltaic (PV) systems. Weather conditions can significantly affect the irradiance, greatly affecting PV array performance. Clouds and shading conditions are significant causes of uncertainty and instability in PV power generation.

Existing approaches require longer “look-back” duration, often 5 days or more, to make accurate predictions. However, obtaining images of the sky for irradiance forecasting can be expensive, resulting in limited data that can practically be relied on for irradiance prediction.

It is with these observations in mind, among others, that various aspects of the present disclosure were conceived and developed.

### BRIEF DESCRIPTION OF THE DRAWINGS

FIG. 1 is a diagram showing a system outlined herein embodied as a PV array facility having smart monitoring devices (SMDs) that provides panel-level sensor measurements, where a connection topology of the PV array adjusts on the irradiance profile;

FIG. 2 is an illustration showing an example Smart Monitoring Device (SMD) that connects to a solar panel for sensing faults and topology reconfiguration, where telemetry is transmitted wirelessly to a centralized hub for predictive decisions;

FIG. 3 is a diagram showing a power output maximization strategy employed by the system of FIG. 1, where weather data is an input to a machine learning technique to estimate irradiance and the PV arrays reconfigure to optimize efficiency by bypassing low-performing panels;

FIG. 4 is a simplified block diagram showing a cascaded Temporal Convolutional Architecture with three Temporal Convolutional Network (TCN) modules which can be implemented by the system of FIG. 1;

FIGS. 5A-5C are a series of simplified illustrations showing dilated convolution with filter size k=3 and increasing dilation rates (where FIG. 5A shows d=1, FIG. 5B shows d=2, and FIG. 5C shows d=4);

FIG. 6 is a simplified diagram showing a receptive field of each layer of the cascaded TCN architecture of FIG. 4;

FIG. 7 is a simplified block diagram showing a Global Horizontal Irradiance (GHI) forecasting pipeline of the system of FIG. 1;

FIG. 8 is a diagram illustrating a data partitioning strategy for training and validation of the cascaded TCN architecture of FIG. 4;

FIG. 9 is a graphical representation showing performance of the system (e.g., using TCN) of FIG. 1 compared with LSTM, particularly showing training loss and validation loss;

FIG. 10 is a graphical representation showing performance of the system (e.g., using TCN) of FIG. 1 compared with LSTM, particularly showing error metrics on test data with 3-day look-back;

FIG. 11 is a graphical representation showing performance of the system (e.g., using TCN) of FIG. 1 compared with LSTM, particularly showing error metrics on test data with 5-day look-back;

FIG. 12 is a graphical representation showing performance of the system (e.g., using TCN) of FIG. 1 compared with LSTM, particularly showing how mean squared error for the TCN and LSTM models increases as sequence length increases (as the number of days increases, TCN performs significantly better than LSTM due to efficient data history capture); and

FIG. 13 is a simplified block diagram showing an example computing device that can be used to implement aspects of the system of FIGS. 1, including aspects shown in FIGS. 3-8.

Corresponding reference characters indicate corresponding elements among the view of the drawings. The headings used in the figures do not limit the scope of the claims.

### DETAILED DESCRIPTION

### I. Introduction

Solar power has emerged as one of the most effective renewable energy sources in recent years. Solar irradiance forecasting has become necessary in determining photovoltaic (PV) array power generation with the increased integration of utility-scale solar arrays into the energy grid. In PV systems, power output depends on the sun's intensity, which depends on cloud cover and other meteorological parameters. This irradiance depends on the sun's position and atmospheric conditions, including humidity, pressure, and dew point. Cloud patterns and types affect how the sun's rays reach the Earth's surface. Cloud shading is one of several significant causes of statistical uncertainty in photovoltaic power output, a planning challenge for electrical power utility companies. It has been shown that solar irradiance is a valuable indicator of PV array power production.

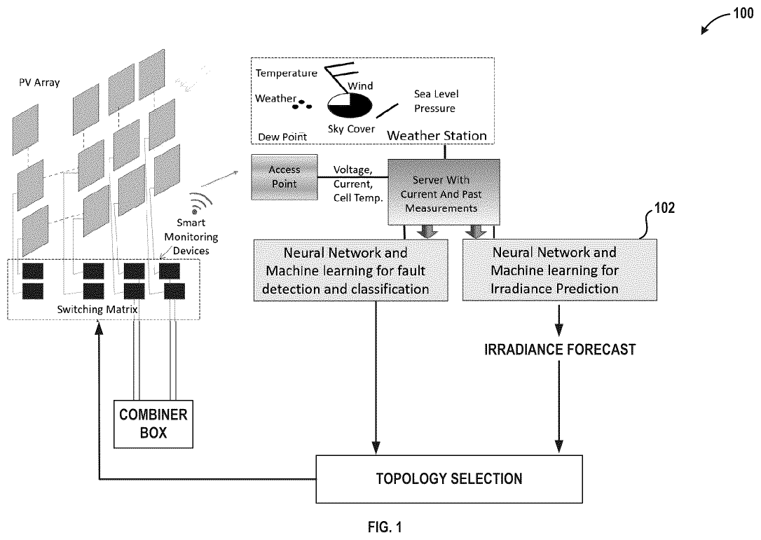

The present disclosure outlines a system that implements a weather-derived solar irradiance forecasting strategy for use with regulating and planning operation of a utility-scale solar array. As illustrated in FIG. 1, a system 100 can include a cyber-physical solar (photovoltaic, or “PV”) array that uses several smart monitoring devices (SMD) to monitor PV panel voltage, current, and temperature features. These features enable the system 100 to control and/or reconfigure a topology of the PV array. These panel-wise features aid in automating PV fault detection and power optimization. Importantly, the system 100 includes an irradiance prediction network 102 that incorporates a cascaded temporal convolutional network (TCN) to predict an irradiance forecast, which can be used to reconfigure a topology of the PV array as needed to maximize power output and efficiency. The use of adaptively increasing dilation in the cascading TCN architecture, combined with strong feature selection and an unconventional stride arrangement of the cascaded TCN architecture enables the system 100 to generate irradiance forecasts for controlling a PV array topology within a shortened observation period (24 hours) while maintaining a hardware implementation that is compact enough for use at a PV array control device.

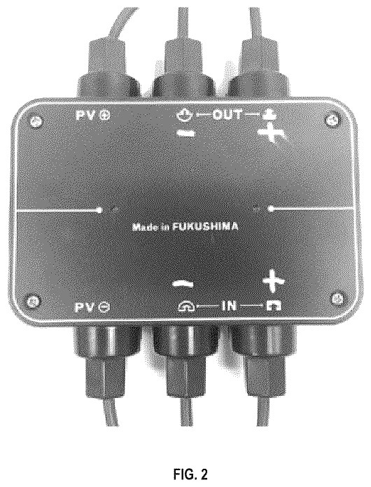

As shown in FIG. 2, an SMD of the system 100 includes sensors, an embedded CPU, relays for topology reconfiguration, and a wireless transceiver for communications. Each SMD connects to a solar panel for sensing faults and for implementing topology reconfiguration. Telemetry data is transmitted wirelessly to a centralized hub for control decisions. SMDs provide continuous monitoring and control of the PV array connection topology.

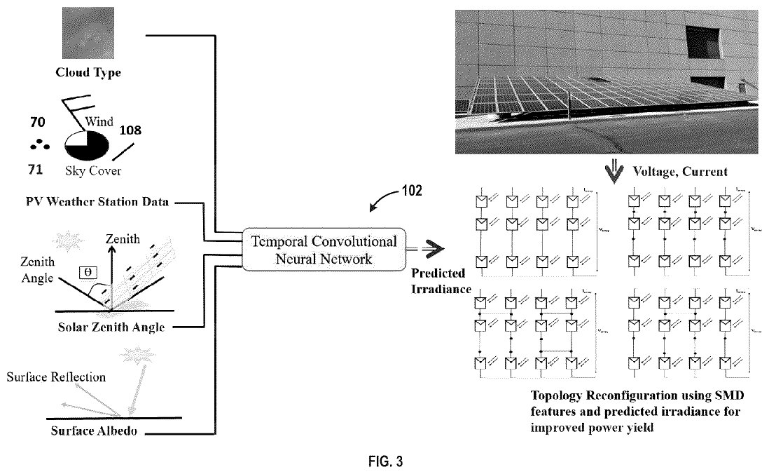

A computer-implemented irradiance forecasting technique outlined herein uses data that can be easily obtained from a weather station to estimate current and future solar irradiance, including estimating the actual solar irradiance as a decision feature. As shown in FIG. 3, a PV topology reconfiguration control element of the system 100 seeks to maximize power output and/or array efficiency based on an output of the irradiance prediction network 102. In one example, the system 100 uses SMDs with relay connections that switch between four PV panel topologies: Series-Parallel, Total Cross Tied, Bridge Link, and Honey-Comb. The PV array can switch between the connection topologies based on the predicted irradiance to maximize the power yield, i.e., by bypassing low-performing panels. In conjunction with the topology reconfiguration control element, the system 100 can implement automated irradiance forecasting as outlined herein which offers a data-driven cyber-physical system approach for predicting and maximizing future PV power output.

The system 100 employs machine learning (ML) techniques from the technical discipline of time-series forecasting to develop a method for irradiance estimation forecasting. One implementation of an ML model is trained using multivariate meteorological weather data from the National Solar Radiation Database (NSRDB). This dataset includes region-specific historical weather data and is used for many predictive tasks. One of these weather quantities is known as Global Horizontal Irradiance (GHI) which quantifies the terrestrial irradiance illuminating a flat surface horizontal to the Earth's surface. The systems outlined herein estimates future irradiance values and how it changes over time.

For benchmark evaluation, a subset of NSRDB is used as an input to forecast GHI for the next hour ahead, with the true measured GHI compared to measured error. Validation results show improved GHI numeric prediction performance beyond the state-of-the-art baselines with the systems and methods outlined herein with only one day's data look back (at 30-minute data resolution). Additional validation results demonstrate performance with additional historical data. Furthermore, the present disclosure shows results of a feature ranking experiment using a “leave one out” strategy to determine which features express the highest correlation to irradiance. Key contributions of this disclosure include:
1) A one-day look-back irradiance forecasting model for power output prediction based on several numeric and categorical weather features.
2) A feature ranking experiment to identify the weather features most strongly correlated with the irradiance prediction.
3) An ablation study based on the quantity of look-back data, thereby evaluating the performance of the system outlined herein against three regression models for irradiance forecasting.
   a. Related Work

Future irradiance estimation is a problem with significant implications for electrical grid management and stability. Recent artificial neural networks (ANN) based methods use real-time meteorological measurements to develop GHI-based forecasting models. This research is significant for estimating irradiance in overcast skies when such shading conditions cause large GHI fluctuations. It has been documented that densely connected ANN methods struggle to model time-series data and phenomena.

Long short-term memory (LSTM) neural network architectures are also used for irradiance prediction. These can model sequential weather conditions, learning a history of past events by modeling these as a sequence of hidden states. Research shows that these LSTM methods perform well for solar irradiance prediction. Long short-term memory (LSTM) is regarded as a state-of-the-art algorithm for time-series data analysis and regression.

New variations of neural architectures have shown state-of-the-art results on the time-series forecasting problem. Researchers have combined LSTM and convolutional neural network (CNN) techniques for irradiance prediction and similar use cases. The literature has also explored attention-based transformers and vision architectures to improve the irradiance forecasting performance. The highest performing methods may utilize sky cameras and satellite images for GHI forecasting. These have improved performance compared to environmental models for irradiance prediction. However, obtaining such images of the sky can be expensive due to the sensors required, and there is a lack of open-source image data for such purposes.

In recent years, temporal convolutional networks (TCN) have become a state-of-the-art method for sequence modeling problems. Similar to the spatial invariant property of conventional neural network architectures, TCNs have a time-invariant property and can learn a temporal pattern from any time in a data series. Secondly, due to the dilated convolution usage in TCN, they produce robust, multi-scale, temporal features from the data. These are much more robust to temporal variation than ANNs. Furthermore, in practice, TCNs are more numerically stable compared to LSTM. The infinite impulse response feedback in LTSMs is less predictable in its convergence and more challenging to optimize. Further, from an embedded computing device perspective, LSTM-based models are more challenging to implement on hardware. While other methods have utilized TCNs with longer historical look-backs for irradiance prediction, the present disclosure is the first that is capable of utilizing only a 1-day look-back in history combined with the addition of dilated convolution TCN architecture to perform short-term irradiance forecasting.

### II. Methods

In a computer-implemented method for forecasting outlined herein, the irradiance prediction network 102 shown in FIGS. 1, 3 and 4 estimates GHI using a modified TCN architecture. For the purposes of the present disclosure, input features (historical GHI and various meteorological features) can be represented as a matrix X=(x₁, x₂, . . . . x_{T}), xₜ ∈ [symbol] ^{N} where xₜ is an input vector of weather data for a particular time sample (e.g., nine meteorological features are used along with historical GHI for one implementation where the input vector is of dimension N=10, however note that other implementations can use additional or fewer meteorological features in the input vector). T represents the number of time steps in the input data. Based on data resolution of one-half hour per data point for one example implementation, T=48 time steps were selected, i.e., one day's worth of data. A TCN outlined herein produces a mapping from the input to the output, which is given by,

$${\hat{y}}_{T + 1} , {\hat{y}}_{T + 2} , … {\hat{y}}_{T + h} = ℱ ( {x}_{1} , {x}_{2} , … {x}_{T} ) \qquad ( 1 )$$

where yᵢ is the true GHI scalar value, ŷᵢ is the estimated GHI value generated by the TCN, h is a number of time steps in the future, and [symbol] represents the TCN. In an example implementation, the TCN predicts two time steps into the future, equivalent to one hour ahead or h=2. The TCN applies causal constraints on this mapping, with output ŷₜ₊₁ only depending on inputs until step t. The TCN ( [symbol] ) outlined in the following section minimizes a loss L (y_{T+1}, y_{T+2}, . . . y_{T+h}, F (x₁, x₂, . . . . x_{T})) between the actual and predicted outputs.
II a. Temporal Convolutional Neural Network

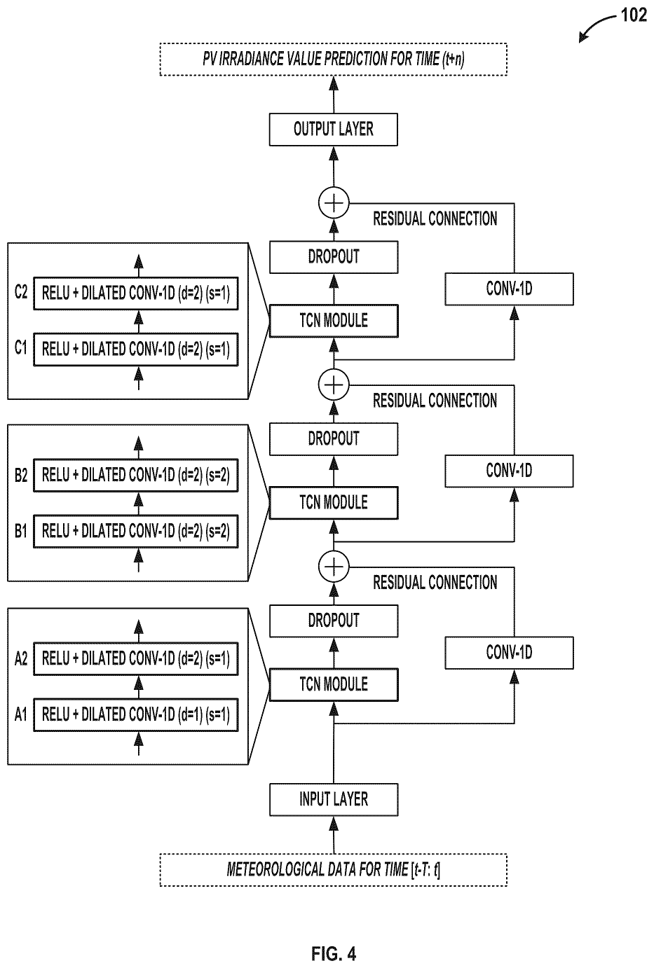

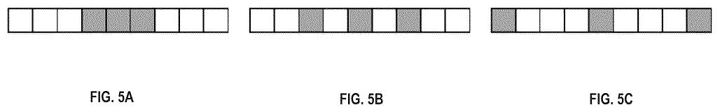

FIG. 4 illustrates a modified TCN architecture used by the system 100 for GHI forecasting. The TCN architecture is customized to include 3 cascaded TCN modules, each with a specifically-selected dilation parameter for augmenting 1-dimensional convolutional layers. In the example implementation of FIG. 4, each TCN module includes two convolution layers with a unique dilation rate varying from one to two. The primary advantage of TCNs over regular convolutional networks is dilation. Unlike conventional convolution typically seen in CNNs, dilated convolutions increase the receptive field size (as shown in FIGS. 5A-5C) based on the dilation factor. An increased receptive field can simultaneously observe a wider time window and extract more accurate features. This element aids in a more accurate and robust mapping of temporal dependencies and a richer context. A dilated convolution on element s of the 48 time step input sequence X is given by,

$$D ( s ) {\sum }_{i = 0}^{k - 1} f ( i ) {X}_{s - di} \qquad ( 2 )$$

where X=(x₁, x₂, . . . . x_{T}) represents the input sequence over an observation interval as explained in Sec. II, s is the discrete time domain, d is the dilation rate, f is the time window to sample from, k is the filter kernel length, and s-di are the temporally divided past time samples to draw from.

Causality in the TCNs prevents future data leakage by choosing non-negative values of i. FIGS. 5A-5C illustrate dilated convolution with filter/kernel size k=3 and increasing dilation rate (i.e., FIG. 5A shows dilation rate d=1, FIG. 5B shows dilation rate d=2, and FIG. 5C shows dilation rate d=4). Dilation rates up to d=4 were studied; however, as the input data is intentionally limited to high-resolution (30-minute) time series with a limited look-back window (1-day or 5-day), larger dilation rates (e.g., d=4) did not appear to significantly reduce prediction errors. By constraining dilation rate to a maximum of d=2 for this particular use case, the TCN maintains the ability to capture both local fluctuations and medium-range dependencies without introducing unnecessary complexity. This range was found to ensure flexibility in learning multi-scale temporal patterns while preventing over-dilation, which could degrade performance on fine-grained solar irradiance data. In particular, the cascaded TCN is shown in FIG. 4 is configured to apply a sequence of causal one-dimensional convolutions over the set of meteorological features according to an adaptive dilation schedule. A total receptive field of a final causal one-dimensional convolution of the sequence of causal one-dimensional convolutions spans the observation interval. Additionally, the stacked architecture of the cascaded TCN inherently expands the effective receptive fields, making higher dilation rates redundant for this task. Thus, the 1-2 dilation rate range provides an optimal balance between feature extraction efficiency and forecasting accuracy for short time horizons.

Unlike conventional cascading TCN architectures which typically feature fixed dilation, the architecture shown in FIG. 4 enables the TCN to dynamically adjust its receptive field deeper into each respective TCN module, e.g., a first TCN module starts with a dilation rate of 1 (no gap); a second TCN module starts with a dilation rate of d=2 (gap of 1); and a third TCN module starts with a dilation rate of d=2. This enables the TCN architecture to capture context from temporal data at different scales, leading to a more comprehensive representation of patterns. In other words, the network can see a “bird's eye view” of the time series data at different scales, resulting in richer information that can be used for prediction. This is particularly beneficial for PV array control because the TCN can still capture a complex data representation with limited data from previous days, leading to more accurate prediction even with a shorter lookback time.

Some typical TCN architectures can be thought of as equivalent to a single TCN module (with more dilated convolution layers with growing dilation) with residual connection without stacking more than one TCN module. These architectures are effective when the input time series data has a lot of time steps, i.e., for longer lookbacks. Other typical TCN architectures may have stacked TCN modules with fixed dilation, i.e., without controlling the dilation rate between layers. For one implementation of the TCN architecture shown in FIG. 4, a quantity of dilated convolution layers within each TCN module is restricted to 2 (to control the model size even with stacking), in addition to controlling the size of adaptive dilation (i.e., between d=1 and d=2 inclusive, optimized during training) which was empirically found to perform better for shorter lookback periods.

In addition to the use of dilation, the three TCN modules of the system 100 are implemented in a cascading fashion. The convolutional outputs of each TCN module (i.e., the residuals) are combined with the input features of the next module. The output of the previous two convolutional layers is added to the current input to produce the input for the next module. This operation can be written as,

$${X}^{i + 1} = T ( {X}^{i} ) + {X}^{i} \qquad ( 3 )$$

where Xⁱ represents the input to the current TCN module, T(Xⁱ) represents the transformed input and Xⁱ⁺¹ represents the input to the next module. To ensure that T(Xⁱ) and Xⁱ have identical dimensions, an optional linear transformation is applied to the input. The residual connections aid the model in learning the input distribution and the transformed versions of the input distribution.

Further, each TCN module includes a temporal stride parameter. In the implementation of FIGS. 4, both dilated convolution layers within the second TCN module feature a temporal stride of s=2, while the other dilated convolution layers within the first and third TCN modules feature a temporal stride of s=1. This results in downsampling within the temporal dimension to expand the total receptive field of the TCN architecture, ensuring that a receptive field of the final layer spans the observation interval (e.g., 24 hours or 48 samples) while limiting complexity of the TCN architecture.

A receptive field at a final layer L of the TCN architecture can be expressed as:

$$R {F}_{L} = 1 + {\sum }_{l = 1}^{L} {d}_{l} ( {k}_{l} - 1 ) ( {\prod }_{r = 1}^{l - 1} {s}_{r} ) .$$

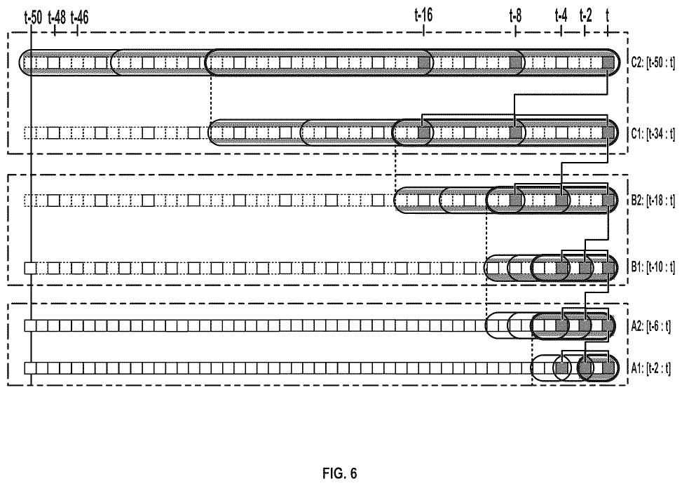

FIG. 6 demonstrates receptive field growth of the TCN architecture of FIG. 4 as a result of the dilation and temporal stride scheme outlined above. In the diagram of FIG. 6, squares correspond to individual samples that collectively span an observation interval (e.g., 24+hours) with each square representing a set of meteorological features (as a vector) for a given time interval (e.g., 30 min). With the use of dilation rates [(1, 2), (2, 2), (2, 2)], stride [(1, 1), (2, 2), (1, 1)] and kernel size=3 the overall receptive field=51.

As shown with additional reference to FIG. 4, a first layer (“A1”) of the first TCN module applies a first causal one-dimensional convolution having a first dilation rate d=1 to the set of meteorological features for the observation interval, with kernel k=3 and stride s=1. A total receptive field of the first layer spans [(t−2):t]. A second layer (“A2”) of the first TCN module applies a second causal one-dimensional convolution having a second dilation rate d=2 to the set of meteorological features for the observation interval, with kernel k=3 and stride s=1. Due to the increase in dilation rate, the total receptive field of the second layer spans [(t−6): t]. Following the second causal one-dimensional convolution as an output of the second layer, as shown in FIG. 4, the TCN architecture combines the output of the second layer with a first parallel causal one-dimensional convolution applied to the set of meteorological features for the observation interval at a first residual connection, the first parallel causal one-dimensional convolution having a first dilation rate (d=1),

A third layer (“B1”) belonging to the second TCN module applies a third causal one-dimensional convolution having a second dilation rate d=2 to an output of a preceding layer of the cascaded temporal convolutional network, with kernel k=3 and stride s=2. The increase in stride “skips” samples, effectively downsamples the result of the preceding operation prior to application of the third causal one-dimensional convolution, thereby increasing the total receptive field while managing total computational complexity. Using different strides at different stages allowed for multi-scale modelling while maintaining the model depth. In the diagram of FIG. 6, skipped samples are shown using dotted lines. A total receptive field of the third layer spans [(t−10): t]. A fourth layer (“B2”) of the second TCN module likewise applying a fourth causal one-dimensional convolution having the second dilation rate to an output of the third layer, with kernel k=3 and stride s=2. This once again downsamples the result of the third causal one-dimensional convolution prior to application of the fourth causal one-dimensional convolution. A total receptive field of the fourth layer spans [(t−18): t]. Similarly, following the fourth causal one-dimensional convolution as an output of the fourth layer, as shown in FIG. 4, the TCN architecture combines the output of the fourth layer with a second parallel causal one-dimensional convolution applied to the result of the first residual connection at a second residual connection, the second parallel causal one-dimensional convolution having a first dilation rate (d=1).

A fifth layer (“C1”) belonging to the third TCN module applies a fifth causal one-dimensional convolution having a second dilation rate d=2 to an output of a preceding layer of the cascaded temporal convolutional network, with kernel k=3 and stride s=1. Although stride s=1 for both layers of the third TCN module, the downsampled samples from the second TCN module having stride s=2 propagate into the vectors that the third TCN module operates on. A total receptive field of the fifth layer spans [(t−34): t]. A sixth layer (“C2”) applies a sixth causal one-dimensional convolution having the second dilation rate d=2 to an output of the fifth dilated layer. A total receptive field of the sixth layer spans [(t−50): t]. Likewise, following the sixth causal one-dimensional convolution as an output of the sixth layer, as shown in FIG. 4, the TCN architecture combines the output of the sixth layer with a third parallel causal one-dimensional convolution applied to the result of the second residual connection at a third residual connection, the second parallel causal one-dimensional convolution having a first dilation rate (d=1).

Finally, throughout the TCN architecture, a Rectified Linear Unit (ReLU) activation function is applied across all layers due to its computational efficiency and effectiveness in mitigating the vanishing gradient problem, which is critical for training deep networks. ReLu's ability to activate only relevant features makes it well-suited for capturing temporal patterns in solar irradiance data. To prevent overfitting while preserving important learned features, a low dropout rate of 0.01 is applied during training. This ensures minimal disruption to the model while reducing the risk of neurons becoming overly dependent on each other. A conservative dropout rate is selected because solar forecasting follows stable diurnal cycles, and excessive dropout could interfere with the model's ability to learn these predictable patterns.

### II B. Experimental Setup

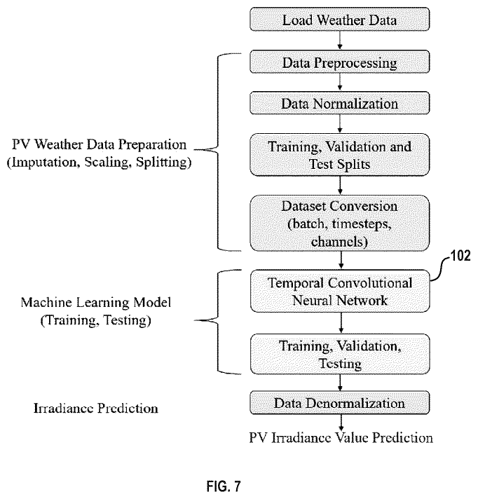

For experimental validation of the GHI forecasting methods outlined herein, the multivariate weather feature data from the National Solar Radiation Database (NSRDB) is used as input to predict the target GHI. FIG. 7 illustrates an example implementation of the end-to-end GHI forecasting pipeline. The first step in the weather data pipeline is data cleaning and preprocessing. During data cleaning, any missing values are substituted to be the nearest available neighbor value, also known as imputation. The data is then normalized by scaling the values to zero mean and standard deviation variance. The dataset is split into training, validation, and test sets and 3-dimensional tensors are created with batch, time step, and feature indices. The training set fits the weights of the TCN model, the validation set tunes the hyperparameters, and the test set derives the performance metrics. The final step of the data processing pipeline is data de-normalization. This operation numerically scales the TCN outputs to obtain the estimated GHI values.

The following subsections of the present disclosure provide further elaboration on the input data features and how to preprocess them to make them suitable for the TCN architecture. These sections also discuss the experimental setup, baselines, and the chosen hyperparameters for the TCN model of the system 100.

### II C. Data Preprocessing

The TCN was trained and evaluated on one year's length of data from the NSRDB database, collected at a thirty-minute time resolution. The data provides several markers for identification, such as ‘city,’ ‘state,” ‘country,’ ‘latitude,’ ‘longitude,’ ‘time zone,’ ‘elevation’, and ‘local time zone.’ Nine significant features in the dataset were used to forecast the GHI value. These features included ‘dew point’ (temperature below which water droplets begin to condense), ‘solar zenith angle’ (angle between the sun's rays and the Earth's surface normal), ‘cloud type,’ ‘surface albedo’ (fraction of the sunlight reflected by the surface of the Earth), ‘wind speed,” precipitable water’ (total atmospheric water vapor present within a vertical column of a unit cross-sectional area extending between any two specified levels), ‘relative humidity’ (a present state of absolute humidity relative to a maximum humidity given the same temperature), ‘temperature’ and ‘pressure’. The dataset categorizes cloud type into thirteen categories: clear, probably clear, fog, water, super-cooled water, mixed, opaque ice, cirrus, overlapping, overshooting, unknown, dust, and smoke categories. NSRDB includes solar and meteorological data for much of the Earth, in regions divided into approximately 4 km by 4 km grid by latitude and longitude. The data used for initial testing and validation focuses on a particular region of Arizona near a utility-scale solar array testbed.

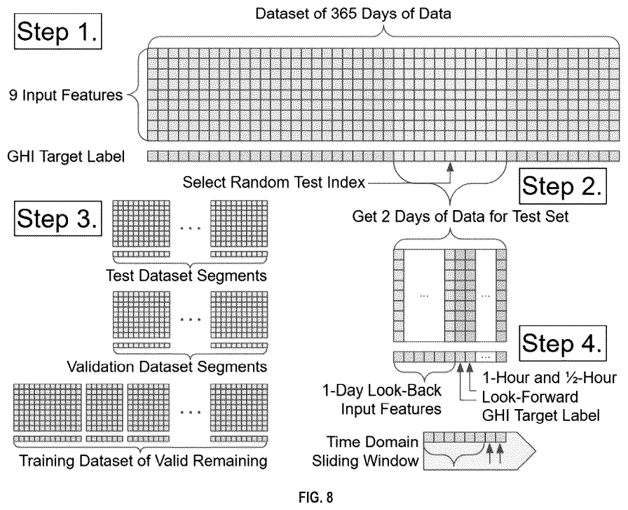

Since the system 100 works with sequential time-series data, splitting the data into several contiguous time sections was essential rather than randomly sampling independently. This process is illustrated in FIG. 8. In Step 1, a full year of data was initialized. Based on frequency of the data capture, 365 days in a year resulted in 17520 samples available in the dataset. Next, in Step 2, the data was segmented into sections of 96 time samples: two days' worth of data starting from a random time index. The TCN uses 48 samples as input: one day's data. Two additional GHI values were also included since a key purpose of the system is to forecast up to an hour into the future. Therefore, at a minimum, each segment must include 50 sequential time samples: the first 48 samples predict the subsequent two samples. This random 2-day selection was repeated in Step 3 to form a time-distributed test dataset with approximately 15% of the overall data. 27 segments were selected, with recorded data of 2 days each to be used as the test set. Combined, this totaled 2592 samples to form the test set, although these samples should not be concatenated since each describes a unique sequence. Following this methodology, we 27 sequences of 96 samples each were selected at random from the remaining 14928 samples for inclusion within a similar validation set. Finally, in Step 4, when reading back the data, a time-domain sliding window shifts to predict the remaining 46 samples of the 96 total. The remaining 12336 samples were filtered to ensure that segments included within the training set were 50 samples or longer. Using this method, the training set was constructed from approximately 70% of the data, the validation set was constructed from 15%, and the test set was constructed from 15%. The test and validation sets were carefully removed from the remaining training dataset to prevent data leakage: if any data set carelessly repeats samples from another sequence, the model will learn from evaluation data. Such an oversight would pollute the samples across multiple datasets and result in an invalidated test.

For ML training, standard normalization scaling was performed on all the features. Categorical cloud-type data was converted using one-hot encoding. When creating batches of training data, the input dataset was re-shaped to have 10 features (9 weather and the past GHI), 48 time-steps in every segment (one day of data), and the target GHI label output to have two time-steps (a one-hour forecast).

### II D. Experiments

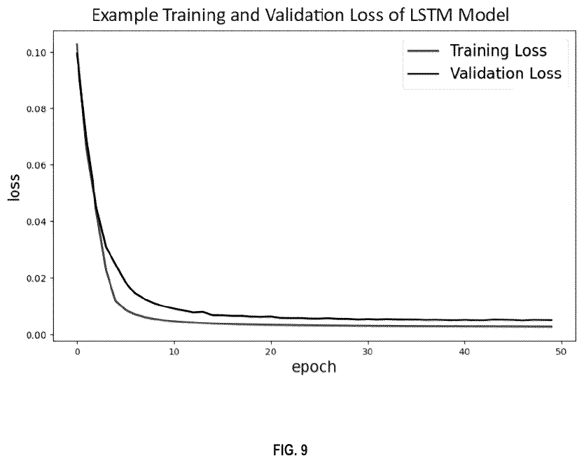

Using the NSRDB dataset as a common benchmark evaluation, the TCN is compared against three baseline networks: a two-layer CNN architecture, a two-layer densely-connected artificial neural network, and an LSTM architecture with 16 hidden units. These methods were chosen as a baseline to represent other state-of-the-art neural architectures published for irradiance forecasting. The present disclosure discusses the highest performing LSTM algorithm to compare with the TCN of FIG. 4. FIG. 9 illustrates one of these training experiments. Additional experiments evaluated the design choices of dilated convolution and residual connection while developing the TCN.

Hyperparameter selection for the neural networks was a mixture of techniques commonly used in literature and extensive empirical analysis during model training. Adam optimizer with a learning rate of 2e-3 and a batch size of 32 was used to train all evaluated neural network models. Several stochastic gradient descent optimizers were considered, but Adam was selected after careful experimentation and literature review. Like many optimizers, Adam has an adaptive learning rate and many parameters that can be adjusted if desired. An ideal learning rate of 2e-3 was determined after a hyperparameter sweep from the default 1e-3 down to 1e-5 and up to 1e-2. Other Adam parameters were not refined: β₁, the decay rate for momentum; β₂, the decay rate for second-order gradients; and ε, the small value to avoid dividing by zero errors. Several batch sizes were tested for training the TCN, starting from 16, 32, and 64 time-series training examples per training batch. Beyond a batch size of 64, the CUDA compute device used for validation began experiencing out-of-memory errors. 32 examples per batch were found to perform best.

Since numeric regression was performed to generate irradiance prediction values, we the mean squared error (MSE) loss function is used to train TCN and all baseline methods. While several regression loss functions exist, MSE was selected because it is recognized for its strong performance across various neural network methods and datasets. Finally, performances of all the methods were evaluated against the test set. These results are shown in Table 1. Additional metrics were calculated, including root mean squared error (RMSE) and mean absolute error (MAE) in addition to MSE, similar to other methods. The equations for these three error metrics are given by:

$$M S E = \frac{1}{n} {\sum }_{i = 0}^{n} {( {y}_{t}^{i} - {\hat{y}}_{t}^{i} )}^{2} \qquad ( 4 )$$

$$R M S E = \sqrt{\frac{1}{n} {\sum }_{i = 0}^{n} {( {y}_{t}^{i} - {\hat{y}}_{t}^{i} )}^{2}} \qquad ( 5 )$$

$$M A E = \frac{1}{n} {\sum }_{i = 0}^{n} ( \vert {y}_{t}^{i} - {\hat{y}}_{t}^{i} \vert ) \qquad ( 6 )$$

where n is the number of data points in the data batch. MAE measures the average error magnitude. Since the error values for this data are relatively small and consistent, the squared term in MSE amplifies statistical noise, leading to faster ML convergence. Like MAE, RMSE has the advantage of being in the same unit of measure as the original target and predicted regression values, while further penalizing outliers. All simulations were done using Python. Keras library was used to implement the TCN, LSTM, and other neural network models. All TCN and baseline methods were trained on an NVIDIA GTX 1080.

### III. Results

TABLE 1
Error Metrics on test data. TCN provides the
lowest error compared to the baselines.

| | Conv 1D | Dense | | Modified |
|---|---|---|---|---|
| | CNN | ANN | LSTM | TCN |
| MSE | 0.16 | 0.12 | 0.007 | 0.006 |
| RMSE | 0.40 | 0.35 | 0.082 | 0.075 |
| MAE | 0.23 | 0.18 | 0.052 | 0.051 |

This section shows the test dataset's evaluation results using the TCN and baseline methods. As mentioned in Section II, the MSE, RMSE, and MAE were used as the error metrics for performance evaluation. Note that all the methods are derived from normalized scaled data.

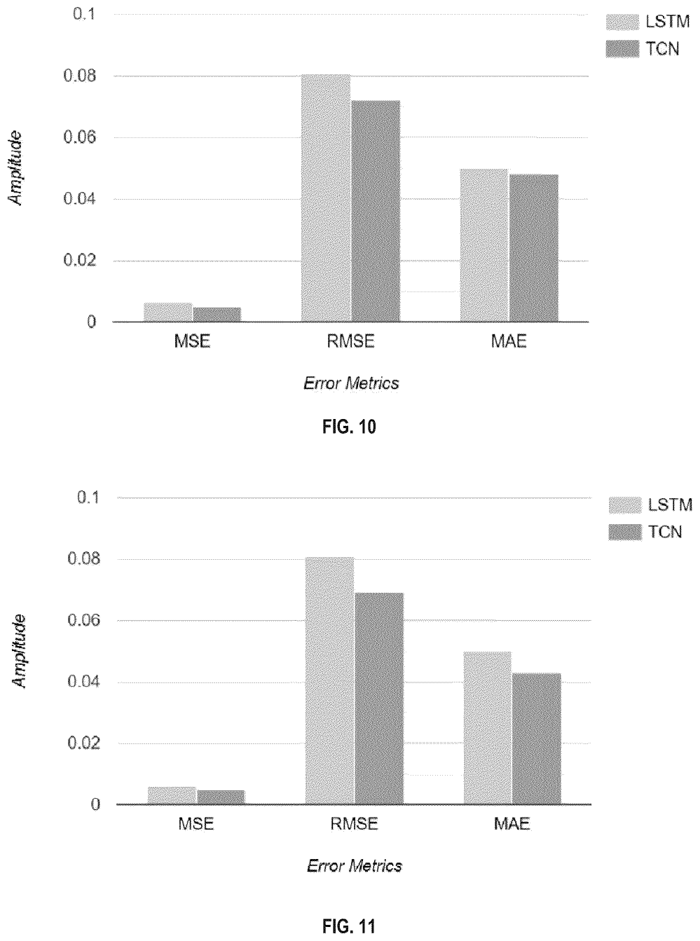

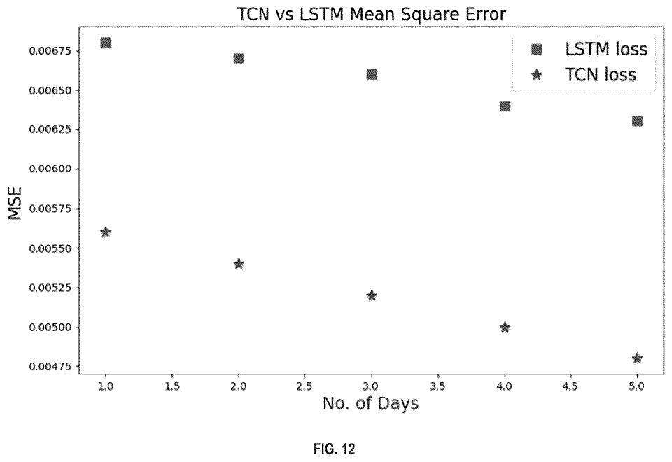

It is evident from Table 1 that the LSTM and TCN models provide significant improvement over other methods. This comparison between LSTM and TCN is also shown in FIG. 10, and FIG. 12 presents a closer view of the MSE values. With the LSTM, the hidden state can capture the temporal information well. With TCN, the improvements are attributed to the efficient feature extraction and rich temporal context of the dilated convolutions. Dilation significantly increases the receptive field size by spacing out the filter elements, allowing it to capture a larger area of the time-domain input without adding extra parameters, thus providing a more extended context for feature extraction without significantly increasing computational cost. Importantly, using different dilation factors in our three TCN modules improved multi-scale embedded information capture.

Note that the results reported in Table 1 use all nine input features. In contrast, the ablation study in the subsequent section does not use all input features simultaneously.

### III A. Ablation Study

An ablation study is also presented based on the past look-back length using TCN and LSTM models. When the models are exposed to longer sequences, as shown in the results plotted in FIG. 11 compared to the baseline in FIG. 10, both models can better capture the inherent patterns in the temporal data due to a more extended input context. A thought-provoking result can be observed in FIG. 10. As the sequence length of the input data increases, the MSE difference between TCN and LSTM grows. One can infer that this behavior is due to the ability of the specialized dilation scheme of the TCN to learn a representation of data history more effectively.

Furthermore, a feature ranking experiment is also performed to determine which features strongly correlate with GHI. A leave-one-out experiment was conducted for all nine input features (except GHI) to determine the drop in prediction performance in the absence of each feature. Based on careful empirical analysis, solar zenith angle (SZA), cloud type, and surface albedo are features most strongly correlated with GHI. The RMSE on the test set increased on average 0.090 in the absence of SZA, 0.087 in the absence of cloud type, and 0.079 without the surface albedo as the feature.

### IV. Discussion

The present disclosure outlines a system 100 that models solar irradiance with dependency on several weather-based attributes to predict irradiance, which can be used to control a PV array to maximize power output and efficiency. The system 100 includes a custom TCN architecture combining 3 TCN modules, each exploiting different dilated convolutions. The disclosure shows that with precise hyperparameter tuning, TCN can perform GHI forecasting with only a one-day look back. When evaluated on a test set, all error metrics of the system 100 outperform the best-in-class published baselines, with RMSE significantly lower than these alternatives. Furthermore, the disclosure provides an ablation study, which shows that as the number of input time steps increases, the performance of all the methods improve. However, the performance improvement of the system 100 using TCN improves at a more significant rate. Using a leave-one-out experiment, the set of weather features mostly closely correlated to irradiance is determined. The predictive model of the system 100 outlined herein can serve as a proof of concept to predict incident irradiance at a solar array and can aid in predicting the power output. Power utilities can use this predictive capability to maintain a consistent power grid.

By achieving accurate GHI forecasts using only a one-day look-back window, the systems outlined herein reduce computational overhead and data dependency compared to traditional deep learning approaches. For the research community, the present disclosure provides a deep learning framework for hyperparameter-optimized TCNs in renewable energy forecasting. Industry stakeholders, such as grid operators and solar farm managers, can leverage this efficient model for real-time energy scheduling and cost reduction. Additionally, the findings highlight the importance of region-specific model tuning, encouraging further studies on adaptive renewable forecasting in diverse climate.

### V. Computer-Implemented System

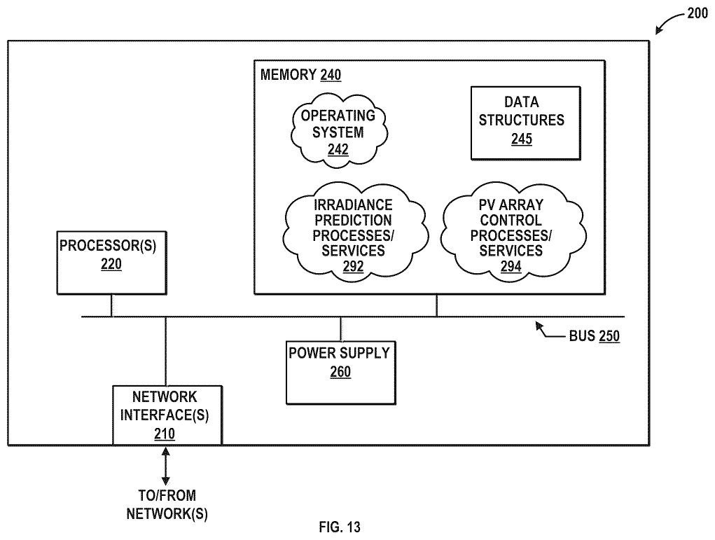

FIG. 13 is a schematic block diagram of an example device 200 that may be used with one or more embodiments described herein, e.g., as a component of system 100 implementing aspects of various methods and modules described herein with respect to FIGS. 1, and 3-8.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system 100 and the methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include irradiance prediction processes/services 292 and may also include PV array control processes/services 294, which can include aspects of the methods and/or implementations of various modules described herein with respect to FIGS. 1, and 3-8. Note that while irradiance prediction processes/services 292 and PV array control processes/services 294 are illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the irradiance prediction processes/services 292 and PV array control processes/services 294 are shown as standalone processes, those skilled in the art will appreciate that these processes may be executed routines or modules within other processes.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

Irradiance prediction processes/services 292 and PV array control processes/services 294 can collectively embody a method outlined herein that is performed by the system 100 with respect to Section II and FIGS. 1, and 3-8. The memory 240 can include instructions executable by the processor to perform aspects of the method, including: accessing meteorological data including a set of meteorological features over an observation interval; and generating an irradiance forecast for a subsequent time interval based on an output feature set produced by a cascaded temporal convolutional network operating on the set of meteorological features for the observation interval, the cascaded temporal convolutional network being configured to apply a sequence of causal one-dimensional convolutions over the set of meteorological features according to an adaptive dilation schedule, wherein a total receptive field of a final causal one-dimensional convolution of the sequence of causal one-dimensional convolutions spans the observation interval. The set of meteorological features can include, but are not limited to: solar zenith angle, cloud type, and surface albedo. The plurality of time steps can have a total duration of 24 hours.

The three or more temporal convolutional network modules can include: a first temporal convolutional network module having a first convolutional output; a second temporal convolutional network module having a second convolutional output; and a third temporal convolutional network module having a third convolutional output. The second temporal convolutional network module combines the first convolutional output, a first residual output, and input features of the second temporal convolutional network module as input. Likewise, the third temporal convolutional network module combines the second convolutional output, a second residual output, and input features of the third temporal convolutional network module as input. Each temporal convolutional network module can be respectively followed by a dropout layer. Further, each temporal convolutional network module can be respectively associated with a residual connection having a residual output that combines with an output of the temporal convolutional network module.

The system 100 can include a photovoltaic array topology control device operable for selectively configuring a connection topology of a plurality of panels of a photovoltaic array. Further, the method can further include instructions executable by the processor to perform aspects of the method including: applying a control signal to the photovoltaic array topology control device that configures the connection topology of the photovoltaic array to maximize a power output of the photovoltaic array for the subsequent time interval based on the irradiance forecast.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A photovoltaic array control system, comprising:
a photovoltaic array topology control device operable for selectively configuring a connection topology of a plurality of panels of a photovoltaic array; and
a processor in communication with a memory, the memory including instructions executable by the processor to:
access meteorological data including a set of meteorological features over an observation interval;
generate an irradiance forecast for a subsequent time interval based on an output feature set produced by a cascaded temporal convolutional network operating on the set of meteorological features for the observation interval, the cascaded temporal convolutional network being configured to apply a sequence of causal one-dimensional convolutions over the set of meteorological features according to an adaptive dilation schedule, wherein a total receptive field of a final causal one-dimensional convolution of the sequence of causal one-dimensional convolutions spans the observation interval; and
apply a control signal to the photovoltaic array topology control device that configures the connection topology of the photovoltaic array to maximize a power output of the photovoltaic array for the subsequent time interval based on the irradiance forecast.

2. The photovoltaic array control system of claim 1, the set of meteorological features including one or more of: solar zenith angle, cloud type, and surface albedo.

3. The photovoltaic array control system of claim 1, the cascaded temporal convolutional network including:
a first temporal convolutional network module having a first convolutional output;
a second temporal convolutional network module having a second convolutional output; and
a third temporal convolutional network module having a third convolutional output.

4. The photovoltaic array control system of claim 3, the first temporal convolutional network module including:
a first layer that applies a first causal one-dimensional convolution having a first dilation rate to the set of meteorological features for the observation interval; and
a second layer that applies a second causal one-dimensional convolution having a second dilation rate to an output of the first layer.

5. The photovoltaic array control system of claim 3, the second temporal convolutional network module including:
a third layer that applies a third causal one-dimensional convolution having a second dilation rate to an output of a preceding layer of the cascaded temporal convolutional network; and
a fourth layer that applies a fourth causal one-dimensional convolution having the second dilation rate to an output of the third layer.

6. The photovoltaic array control system of claim 5, the third layer downsampling the output of the preceding layer of the cascaded temporal convolutional network and the fourth layer downsampling the output of the third layer.

7. The photovoltaic array control system of claim 3, the third temporal convolutional network module including:
a fifth layer that applies a fifth causal one-dimensional convolution having a second dilation rate to an output of a preceding layer of the cascaded temporal convolutional network; and
a sixth layer that applies a sixth causal one-dimensional convolution having the second dilation rate to an output of the fifth layer.

8. The photovoltaic array control system of claim 3, each temporal convolutional network module being respectively followed by a dropout layer.

9. The photovoltaic array control system of claim 3, the cascaded temporal convolutional network combining convolutional outputs of each respective temporal convolutional network module with a corresponding residual output of a parallel causal one-dimensional convolution layer, the parallel causal one-dimensional convolution layer having a first dilation rate.

10. The photovoltaic array control system of claim 1, the observation interval spanning 24 hours.

11. A method of operating a photovoltaic array, comprising:
accessing, at a processor in communication with a memory, meteorological data including a set of meteorological features over an observation interval;
generating an irradiance forecast for a subsequent time interval based on an output feature set produced by a cascaded temporal convolutional network operating on the set of meteorological features for the observation interval, the cascaded temporal convolutional network being configured to apply a sequence of causal one-dimensional convolutions over the set of meteorological features according to an adaptive dilation schedule, wherein a total receptive field of a final causal one-dimensional convolution of the sequence of causal one-dimensional convolutions spans the observation interval; and
generating a control signal for application to a photovoltaic array topology control device that configures a connection topology of a plurality of panels of a photovoltaic array to maximize a power output of the photovoltaic array for the subsequent time interval based on the irradiance forecast.

12. The method of claim 11, the set of meteorological features including one or more of: solar zenith angle, cloud type, and surface albedo.

13. The method of claim 11, further comprising:
applying a first causal one-dimensional convolution having a first dilation rate to the set of meteorological features for the observation interval; and
applying a second causal one-dimensional convolution having a second dilation rate to a result of the first causal one-dimensional convolution.

14. The method of claim 11, further comprising:
applying a third causal one-dimensional convolution having a second dilation rate to a result of a preceding operation of the cascaded temporal convolutional network; and
applying a fourth causal one-dimensional convolution having the second dilation rate to a result of the third causal one-dimensional convolution.

15. The method of claim 14, further comprising:
downsampling the result of the preceding operation of the cascaded temporal convolutional network prior to application of the third causal one-dimensional convolution; and
downsampling the result of the third causal one-dimensional convolution prior to application of the fourth causal one-dimensional convolution.

16. The method of claim 14, the preceding operation being a first residual connection between a result of a second causal one-dimensional convolution and a first parallel causal one-dimensional convolution applied to the set of meteorological features for the observation interval, the first parallel causal one-dimensional convolution having a first dilation rate.

17. The method of claim 11, further comprising:
applying a fifth causal one-dimensional convolution having a second dilation rate to a result of to a result of a preceding operation of the cascaded temporal convolutional network; and
applying a sixth causal one-dimensional convolution having the second dilation rate to a result of the fifth causal one-dimensional convolution.

18. The method of claim 17, the preceding operation being a second residual connection between a result of a fourth causal one-dimensional convolution and a second parallel causal one-dimensional convolution applied to the result of a first residual connection, the second parallel causal one-dimensional convolution having a first dilation rate.

19. The method of claim 11, the observation interval spanning 24 hours.
